(19) United States
(12) Patent Application Publication
(10) Pub. No.: US 2011/0157101 A1
(43) Pub. Date: Jun. 30, 2011

(54) ELECTRONIC WHITEBOARD SYSTEM

(75) Inventor: Jen-Tsorng Chang, Tu-Cheng (TW)

(73) Assignee: HON HAI PRECISION INDUSTRY CO., LTD., Tu-Cheng (TW)

(21) Appl. No.: 12/789,633

(22) Filed: May 28, 2010

(30) Foreign Application Priority Data
Dec. 28, 2009 (CN) 200910312406.2

(51) Int. Cl. G06F 3/033

(52) U.S. Cl. 345/179

(57) ABSTRACT

An electronic whiteboard system includes a projector, at least two image capture devices, an electronic whiteboard, a light pen and a processor. The light pen includes at least two light emitting members respectively emitting different wavelengths of light. The at two image capture devices detects the corresponding wavelengths of light and transmits an image signal to the processor. The processor is connected to the projector and the at least two image capture devices, and then directs the projector to project a colored marker onto the electronic whiteboard. A color of the colored marker is controlled by the light pen.

### BACKGROUND

1. Technical Field

The present disclosure relates to electronic whiteboards, and particularly, to an electronic whiteboard system.

2. Description of the Related Art

Electronic whiteboard systems are widely used in many fields, such as teaching and video conferencing.

An electronic whiteboard system includes a processor, a projector, an infrared whiteboard and a light pen. The processor is electrically connected to the projector and the infrared whiteboard. The infrared whiteboard includes an infrared sensor. The light pen emits an infrared beam. When the light pen is used on the infrared whiteboard, the infrared beam generates a corresponding infrared image. The infrared sensor detects the infrared image, and transmits an image signal to the processor. The processor controls the projector to project a marker on the electronic whiteboard. However, the electronic whiteboard system can only display one color marker, and cannot display different color markers.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a schematic view of a first embodiment of an electronic whiteboard system including a first image capture device and a light pen.

FIG. 2 is a cross-section view of the first image capture device shown in FIG. 1.

FIG. 3 is a partial, enlarged, cross-section view of the light pen shown in FIG. 1.

FIG. 4 is a schematic view of a second embodiment of an electronic whiteboard system including a first image capture device and a light pen.

FIG. 5 is a partial, enlarged, cross-section view of the light pen shown in FIG. 4.

### DETAILED DESCRIPTION

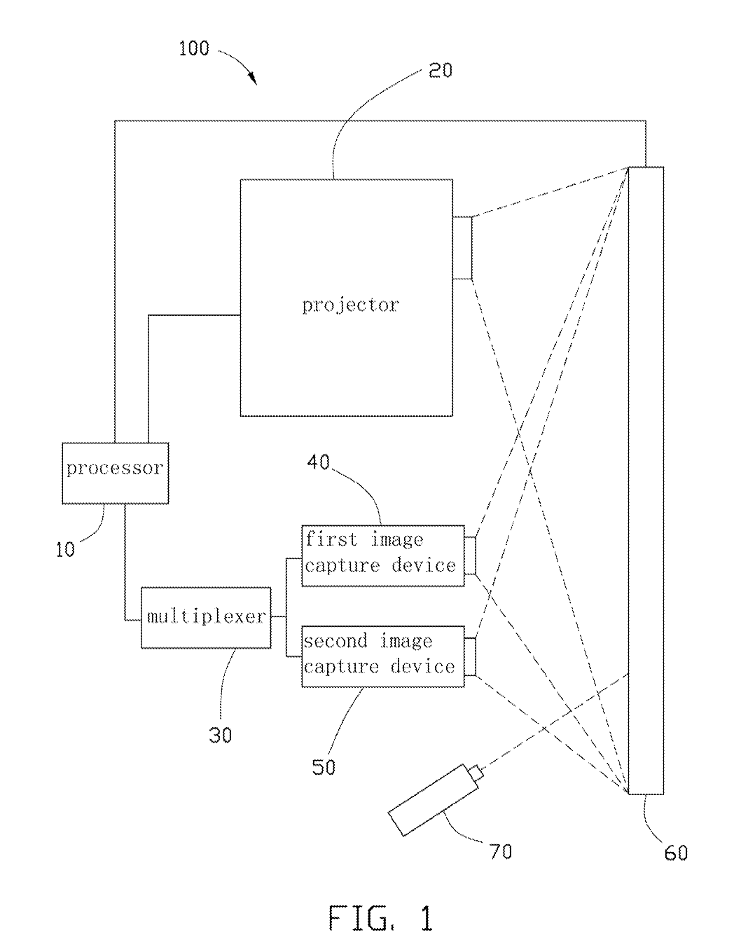

Referring to FIG. 1, a first embodiment of an electronic whiteboard system 100 includes a processor 10, a projector 20, a multiplexer 30, a first image capture device 40, a second image capture device 50, an electronic whiteboard 60 and a light pen 70. The projector 20, the multiplexer 30, and the electronic whiteboard 60 are respectively electrically or wirelessly connected to the processor 10. The first image capture device 40 and the second image capture device 50 are respectively electrically or wirelessly connected to the processor 10 via the multiplexer 30, such that the first image capture device 40 and the second image capture device 50 share a high-speed channel of the multiplexer 30.

The processor 10 controls the projector 20, the multiplexer 30, the first image capture device 40, the second image capture device 50 and the electronic whiteboard 60. The processor 10 can accept an image signal from the first image capture device 40 and the second image capture device 50, and transmit a control signal to the projector 20.

The projector 20 can accept the control signal from the processor 10, and project an image on the electronic whiteboard 60. The control signal contains image information generated by the light pen 70.

The electronic whiteboard 60 is selected from one of a pressure sensitive whiteboard and an infrared whiteboard. The light pen 70 can emit at least two different wavelengths of light.

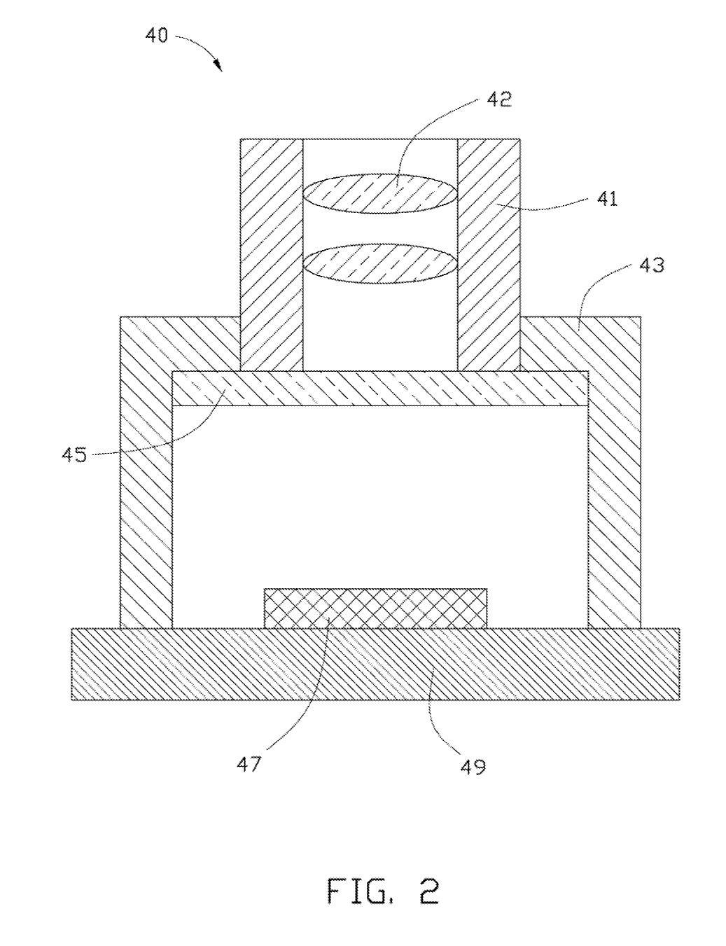

Referring to FIG. 2, the first image capture device 40 includes a lens cone 41, a lens group 42, a bottom frame 43, a first filter 45, an image sensor 47 and a substrate 49. The lens group 42 is received in the lens cone 41. The bottom frame 43 is fixed to an end of the lens cone 41. The first filter 45 is fixed in one end of the bottom frame 43 adjacent to the lens cone 41. The substrate 49 is fixed to other end of the bottom frame 43 to cover the bottom frame 43. The image sensor 47 is fixed on an inner surface of the substrate 49. Incident light from the lens group 42 passes through the first filter 45, and is detected by the image sensor 47. In the illustrated embodiment, the first filter 45 is an infrared narrow bandpass filter that only allows an infrared beam to pass through. The image sensor 47 is a CMOS (Complementary Metal Oxide Semiconductor) sensor.

The second image capture device 50 is similar to the first image capture device 40, except that the second filter (not labeled) is different from the first filter 45. A wavelength of the infrared beam passing through the second filter is different from that of the infrared beam passing through the first filter 45.

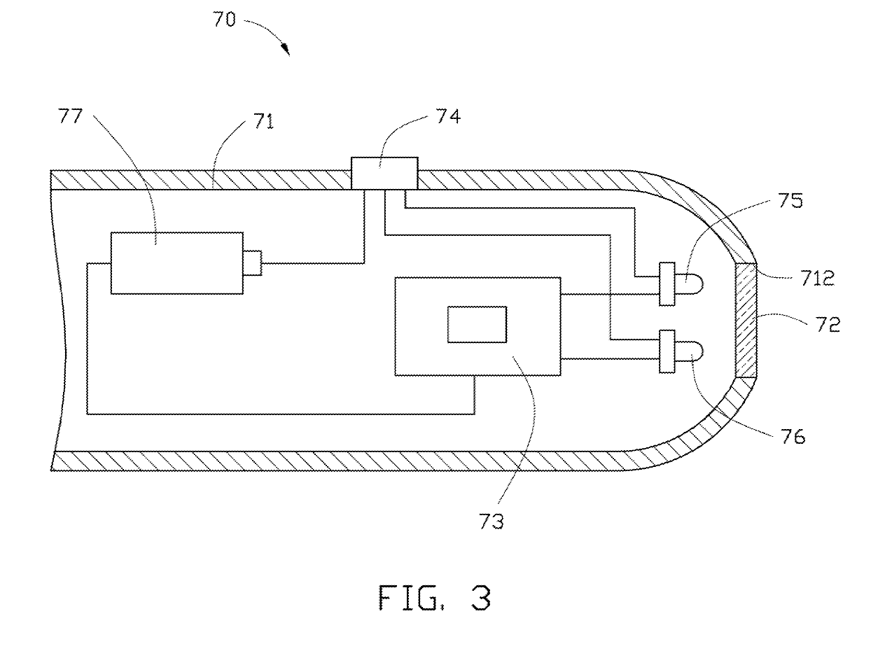

Referring to FIG. 3, the light pen 70 includes a housing 71, a transparent film 72, a circuit board 73, a control switch 74, a first light emitting member 75, a second light emitting member 76 and a battery 77. The housing 71 defines a through hole 712 in an end of the housing 71. The transparent film 72 is fixed in the through hole 712. The circuit board 73 and the battery 77 are received in the housing 71. The control switch 74 is fixed on an outer surface of the housing 71. An anode and a cathode of the battery 77 are respectively electrically connected to the control switch 74 and the circuit board 73. Two electrodes of the first light emitting member 75 and the second light emitting member 76 electrically interconnect the control switch 74 and the circuit board 73. In the illustrated embodiment, the first light emitting member 75 and the second light emitting member 76 are infrared light-emitting diodes. In an alternative embodiment, the first light emitting member 75 and the second light emitting member 76 are other types of light-emitting diodes or a bulb.

A wavelength of a light emitted from the first emitting member 75 is λ₁. A wavelength of a light emitted from the second emitting member 76 is λ₂, where λ₁ and λ₂ are different. The first emitting member 75 and the second emitting member 76 are simultaneously or individually turned on, such that the light pen 70 emits three optical signals represented by λ₁, λ₂ and λ₁+λ₂. The first filter 45 of the first image capture device 40 only allows the light emitted from the light emitting member 75 to pass through. The second filter of the second image capture device 50 only allows the light emitted from the light emitting member 76 to pass through.

Referring to FIGS. 1 and 3, if the light pen 70 is to draw a blue line on the electronic whiteboard 60, the control switch 74 directs the first emitting member 75 to emit light. The light emitted from the first emitting member 75 generates an infrared line on the electronic whiteboard 60. The first image capture device 40 reads the infrared line, and transmits an image signal to the processor 10. The processor 10 directs the projector 20 to project a blue line on the electronic whiteboard 60 corresponding to the infrared line.

The light pen 70 can be used to write other colored markers, for example, a circle, a curvy line. A color of the marker is controlled by the light pen 70, as shown for example, in the Table 1.

TABLE 1
a color of the colored marker controlled by the light pen

| | | A color of the |
|---|---|---|
| Wavelength of emitted light | Image capture device | colored marker |
| λ₁ | The first image capture | Blue |
| | device | |
| λ₂ | The second image | Red |
| | capture device | |
| λ₁, λ₂ | The first image capture | Green |
| | device and the second | |
| | image capture device | |

The light pen 70 emits a light onto the electronic whiteboard 60 to generate an infrared image. The first image capture device 40 and the second image capture device 50 capture the infrared image, and transmit an image signal to the processor 10. The processor 10 directs the projector 20 to project a colored marker on the electronic whiteboard 60 corresponding to the infrared image, the color of the colored marker is controlled by the light pen 70.

It is to be understood that the color of the colored marker can also be more than three, so correspondingly, the number of the light emitting member of the light pen 70 can be more than two. The number of image capture devices can also be more than two.

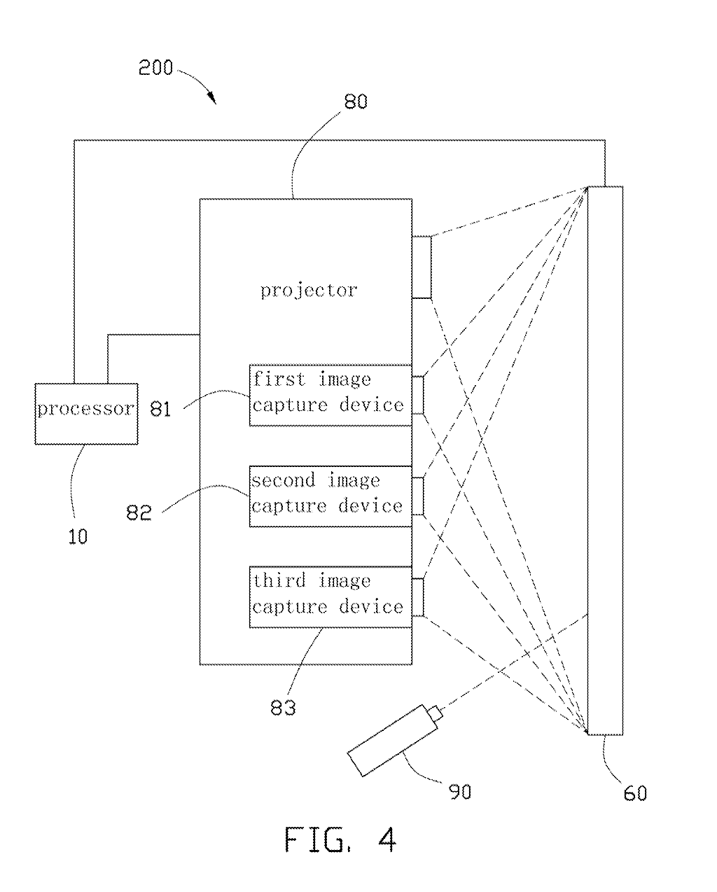

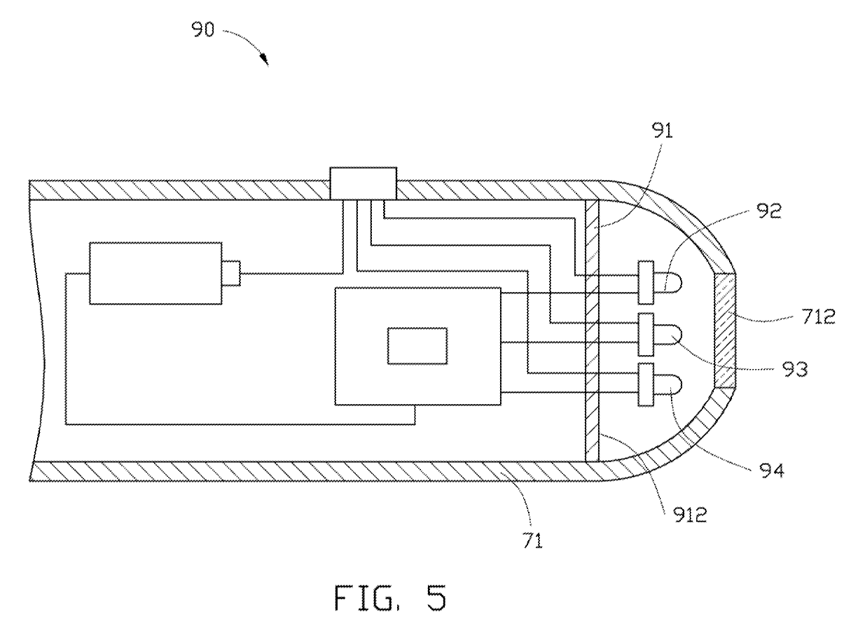

Referring to FIGS. 4 and 5, a second embodiment of an electronic whiteboard system 200 is shown, differing from the first embodiment only in that the electronic whiteboard system 200 further includes a third image capture device 83, and the light pen 90 further includes a third light emitting member 94 and fixing plate 91. The first image capture device 81, the second image capture device 82 and the third image capture device 83 are fixed in the projector 80. The first light emitting member 92, the second light emitting member 93 and the third light emitting member 94 are fixed on the fixing plate 91. The fixing plate 91 is received in the housing 71 opposite to the transparent film 72, and includes a reflecting surface 912 adjacent to the first light emitting member 92, the second light emitting member 93 and the third light emitting member 94. A wavelength of light emitted from the first light emitting member 92, the second light emitting member 93 and the third light emitting member 94 are λ₁, λ₂ and λ₃, respectively. A color of the colored marker is controlled by the light pen 70, as shown for example, in Table 2.

TABLE 2
a color of the colored marker controlled by the light pen

| | | A color of the |
|---|---|---|
| Wavelength of emitted light | Image capture device | colored marker |
| λ₁ | The first image capture | Blue |
| | device | |
| λ₂ | The second image | Red |
| | capture device | |
| λ₃ | The third image capture | Green |
| | device | |
| λ₁, λ₂ | The first image capture | Purple |
| | device and the second | |
| | image capture device | |
| λ₁, λ₃ | The first image capture | Cyan |
| | device and the third | |
| | image capture device | |
| λ₂, λ₃ | The second image | Orange |
| | capture device and the | |
| | third image capture | |
| | device | |
| λ₁, λ₂, λ₃ | The first image capture | Yellow |
| | device, the second | |
| | image capture device | |
| | and the third image | |
| | capture device | |

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. An electronic whiteboard system comprising:
a projector;
at least two image capture devices;
an electronic whiteboard;
a light pen; and
a processor connected to the projector and the at least two image capture devices, wherein the light pen comprises at least two light emitting members respectively emitting different wavelengths of light, the at least two image capture devices detect the corresponding wavelengths of light and transmit an image signal to the processor, and the processor then controls the projector to project a colored marker on the electronic whiteboard, a color of the colored marker being controlled by the light pen.

2. The electronic whiteboard system of claim 1, wherein each of the at least two image capture devices comprises a lens cone, a lens group received in the lens cone and a bottom frame fixed to an end of the lens cone.

3. The electronic whiteboard system of claim 2, wherein each of the at least two image capture devices further comprises a filter fixed in an end of the bottom frame adjacent to the lens cone.

4. The electronic whiteboard system of claim 3, wherein the filter is an infrared narrow bandpass filter.

5. The electronic whiteboard system of claim 3, wherein each of the at least two image capture devices further comprises a substrate fixed to an end of the bottom frame away from the lens cone to cover the bottom frame.

6. The electronic whiteboard system of claim 5, wherein each of the at least two image capture devices further comprises an image sensor fixed on an inner surface of the substrate.

7. The electronic whiteboard system of claim 6, wherein the image sensor is a complementary metal oxide semiconductor sensor.

8. The electronic whiteboard system of claim 1, wherein the light pen further comprises a housing, a control switch fixed on an outer surface of the housing, a circuit board fixed in the housing, a battery electrically connected to the control switch and the circuit board; two electrodes of the at least two light emitting members are electrically connected to the control switch and the circuit board.

9. The electronic whiteboard system of claim 8, wherein the at least two light emitting members are infrared light emitting diodes.

10. The electronic whiteboard system of claim 8, wherein the housing defines a through hole in an end thereof.

11. The electronic whiteboard system of claim 10, wherein the light pen further comprises a transparent film fixed in the through hole.

12. The electronic whiteboard system of claim 11, wherein the light pen further comprises a fixing plate received in the housing opposite to the transparent film.

13. The electronic whiteboard system of claim 12, wherein the fixing plate comprises a reflecting surface adjacent to the at least two light emitting members.

14. The electronic whiteboard system of claim 12, further comprising a multiplexer interconnecting the at least two image capture devices and the processor.
